(19) United States
(12) Patent Application Publication
(10) Pub. No.: US 2026/0133298 A1
(43) Pub. Date: May 14, 2026

(54) LIDAR, AND SIGNAL PROCESSING METHOD AND SIGNAL PROCESSOR APPARATUS THEREOF

(71) Applicant: HESAI TECHNOLOGY CO., LTD., Shanghai (CN)

(72) Inventors: Xiaotong ZHOU, Shanghai (CN); Shaoqing XIANG, Shanghai (CN)

(73) Assignee: HESAI TECHNOLOGY CO., LTD., Shanghai (CN)

(21) Appl. No.: 19/431,131

(22) Filed: Dec. 23, 2025

Related U.S. Application Data
(63) Continuation of application No. PCT/CN2024/083248, filed on Mar. 22, 2024.

(30) Foreign Application Priority Data
Jun. 29, 2023 (CN) 202310787988.X

(51) Int. Cl. G01S 7/487; G01S 7/481; G01S 7/4863; G01S 17/10; G01S 17/89

(52) U.S. Cl. CPC G01S 7/4873; G01S 7/4863; G01S 7/4876; G01S 17/10; G01S 17/89; G01S 7/4815

(57) ABSTRACT

Embodiments of this disclosure provide a LiDAR, and a signal processing method and a signal processor apparatus thereof. The LiDAR includes multiple detectors. The signal processing method for the LiDAR includes the following. A target detector is selected, and an output signal of the target detector is received. A total crosstalk amount caused by other detectors to the target detector is determined. An actual detection signal of the target detector is determined based on the output signal of the target detector and the total crosstalk amount. By using the above solution, noise points generated by crosstalk between detectors in the LiDAR can be eliminated. In such a case, the quality of point cloud can be improved.

### CROSS-REFERENCE TO RELATED APPLICATION(S)

This application is a continuation application of copending International Patent Application No. PCT/CN2024/083248, filed on Mar. 22, 2024, which claims priority to Chinese Patent Application No. 202310787988.X, filed on Jun. 29, 2023, the content of which is incorporated herein by reference in its entirety.

### TECHNICAL FIELD

Embodiments of this disclosure relate to the field of signal processing technologies and, in particular, to a LiDAR, and a signal processing method and a signal processor apparatus thereof.

### BACKGROUND

When multiple detection channels of a Light Detection and Ranging (LiDAR) work in parallel, crosstalk can occur between the multiple detection channels, especially when encountering a detection object with high reflectivity (e.g., a high-reflectivity object).

For example, an echo signal from a detection point C is received within a field of view corresponding to a detection channel B. Due to the high reflectivity of the detection point C, crosstalk can be induced in a detection channel A. In such a case, a detection result is output within a field of view corresponding to the detection channel A. The detection point C can be located outside the field of view corresponding to the detection channel A. In such a case, a detection point C can appear at a position where no detection point C should exist in a detection result (e.g., in a point cloud map), which can generate spurious points (noise points) around the true point. This phenomenon is referred to as “blooming” or “broadening” of the high-reflectivity object.

The “blooming” phenomenon typically manifests in that a point could contour of a normal high-reflectivity object (e.g., a traffic sign) spreads outwards, forming a point cloud shape that is larger than the actual object. And a reflection intensity of the newly generated peripheral portion of the point cloud is relatively low. In other words, “blooming” refers to a phenomenon where after a high-reflectivity object is scanned by laser, the output point cloud expands toward the surrounding area and appears as if it has been “expanded”. In such a case, it is referred to as high-reflectivity “blooming”. Referring to FIG. 1, regions enclosed by solid line frames 10 and 11 correspond to several thin rods. But due to the presence of “blooming” phenomenon, the shapes of these objects are distorted. A large number of noise points (points with relatively lower brightness in FIG. 1) appear around the actual detection points (points with relatively higher brightness in FIG. 1). In some cases, the thin rods are even rendered as spherical objects.

In practical driving scenarios, high-reflectivity objects are very common, such as traffic signs. Echoes reflected from the high-reflectivity objects received by the LiDAR can have high signal intensity. Blooming or broadening can be easily caused in the point cloud, which can affect the quality of the point cloud.

The content of BACKGROUND merely discloses technologies known by applicants, and does not necessarily represent the prior art in this field.

### SUMMARY

In view of this, embodiments of this disclosure provide a LiDAR, and a signal processing method and a signal processor apparatus. Noise points generated by crosstalk between detectors in the LiDAR can be eliminated, which can improve the quality of point cloud.

Firstly, the embodiments of this disclosure provide a signal processing method for a LiDAR. The LiDAR includes multiple detectors. The signal processing method includes:
selecting a target detector, and receiving an output signal of the target detector,
determining a total crosstalk amount caused by other detectors to the target detector, and
determining an actual detection signal of the target detector based on the output signal of the target detector and the total crosstalk amount.

Optionally, the selecting the target detector, and receiving the output signal of the target detector includes:
determining whether an output signal of a detector is a high-reflectivity echo signal, and in response to determining that the output signal is the high-reflectivity echo signal, determining the detector as the target detector.

Optionally, the determining whether the output signal of the detector is the high-reflectivity echo signal includes:
determining whether the output signal of the detector is the high-reflectivity echo signal based on signal characteristics of the output signal of the detector.

Optionally, the signal characteristics of the output signal include at least one of: a noise value, an intensity value, a pulse width of echo waveform, or a slope of the echo waveform.

Optionally, the determining the total crosstalk amount caused by other detectors to the target detector includes:
determining all detectors that cause crosstalk to the target detector as crosstalk detectors, and
performing convolution on crosstalk amounts caused by the crosstalk detectors to the target detector to determine the total crosstalk amount.

Optionally, the performing convolution on the crosstalk amount caused by the crosstalk detectors to the target detector to determine the total crosstalk amount includes:
determining output signals of respective crosstalk detectors, and determining the crosstalk amounts corresponding to the respective crosstalk detectors based on crosstalk coefficients corresponding to the respective crosstalk detectors, and
combining the crosstalk amounts corresponding to the respective crosstalk detectors to determine the total crosstalk amount.

Optionally, the determining the output signals of the respective crosstalk detectors, and the determining the crosstalk amounts corresponding to the respective crosstalk detectors based on the crosstalk coefficients corresponding to the respective crosstalk detectors includes:
determining products of the crosstalk coefficients corresponding to the respective crosstalk detectors and signal intensities of the output signals as the crosstalk amounts corresponding to the respective crosstalk detectors.

Optionally, the crosstalk coefficients are related to distances between the crosstalk detectors and the target detector.

Optionally, the signal processing method further includes: determining obstacle distances based on the output signal of the target detector and the output signals of the respective crosstalk detectors, and in response to a difference between an obstacle distance corresponding to a respective crosstalk detector and the obstacle distance corresponding to the target detector exceeding a predetermined distance threshold, setting a crosstalk coefficient of the respective crosstalk detector to zero.

Optionally, the determining the actual detection signal of the target detector based on the output signal of the target detector and the total crosstalk amount includes:
determining the actual detection signal by subtracting the total crosstalk amount from the output signal of the target detector.

Optionally, the signal processing method further includes:
determining whether a signal intensity of the actual detection signal exceeds a predetermined detection threshold to determine whether the actual detection signal is a valid signal.

Correspondingly, the embodiments of this disclosure further provide a signal processor apparatus for a LiDAR. The LiDAR includes multiple detectors. The signal processor apparatus includes:
a sampler, configured to sample an output signal of a target detector, and
a processor, configured to determine a total crosstalk amount caused by other detectors to the target detector, and configured to determine an actual detection signal of the target detector based on the output signal of the target detector and the total crosstalk amount.

Optionally, the processor is further configured to determine whether an output signal of a detector is a high-reflectivity echo signal, and in response to determining that the output signal is the high-reflectivity echo signal, determine the detector as the target detector.

Optionally, the processor is configured to determine all detectors that cause crosstalk to the target detector as crosstalk detectors, and perform convolution on crosstalk amounts caused by the crosstalk detectors to the target detector to determine the total crosstalk amount.

Optionally, the processor is configured to determine output signals of respective crosstalk detectors, and determine crosstalk amounts corresponding to the respective crosstalk detectors based on crosstalk coefficients corresponding to the respective crosstalk detectors, and combine crosstalk amounts corresponding to respective target detectors to determine the total crosstalk amount.

Optionally, the crosstalk coefficients are related to distances between the crosstalk detectors and the target detector.

Optionally, the processor is further configured to determine obstacle distances based on the output signals of the target detectors and the output signals of the respective crosstalk detectors, and in response to a difference between an obstacle distance corresponding to a respective crosstalk detector and the obstacle distance corresponding to the target detector exceeding a predetermined distance threshold, set a crosstalk coefficient of the respective crosstalk detector to zero.

Optionally, the processor is further configured to determine whether a signal intensity of the actual detection signal exceeds a predetermined detection threshold to determine whether the actual detection signal is a valid signal.

The embodiments of this disclosure further disclose a LiDAR. The LiDAR includes:
an emitter, including multiple lasers, configured to emit a detection signal,
a receiver, including multiple detectors, configured to receive an echo signal corresponding to the detection signal, and
a signal processor apparatus, coupled to the receiver, configured to determine a total crosstalk amount caused by other detectors to a target detector, and configured to determine an actual detection signal of the target detector based on the output signal of the target detector and the total crosstalk amount.

Optionally, the receiver includes a two-dimensional detector array.

For the LiDAR including the multiple detectors, the signal processing method for the LiDAR in the embodiments of this disclosure is used. After the target detector is selected, the total crosstalk amount caused by other detectors to the target detector can be determined. Then, the actual detection signal of the target detector can be determined based on the determined output signal of the target detector and the total crosstalk amount. That is, using the above signal processing method, the total crosstalk amount caused by other detectors to the target detector can be eliminated. In such a case, the actual detection signal of the target detector does not include the crosstalk amount caused by other detectors. In such a case, an influence of the crosstalk between the multiple detectors on a detection result can be eliminated. Noise points caused by the crosstalk can be eliminated. And the quality of the point cloud can be improved.

Furthermore, the detector whose output signal is the high-reflectivity echo signal is determined as the target detector. In such a case, the detector whose output signal is the high-reflectivity echo signal can be processed. Accordingly, computational load can be reduced and processing efficiency can be improved.

Furthermore, whether an output signal of any detector is the high-reflectivity echo signal can be determined based on the signal characteristics of the output signal of any detector. A determination process is simple and easy to implement.

Furthermore, the output signal of the target detector is a result of combined effect of the target detector itself and all crosstalk detectors. In such a case, the total crosstalk amount determined by combining the crosstalk amounts caused by the crosstalk detectors to the target detector by convolution can reflect the crosstalk caused by the crosstalk detectors to the target detector more accurately. Further, accuracy of the determined actual detection signal of the target detector can be enhanced.

Furthermore, the crosstalk amount can be determined based on the output signals of the respective crosstalk detectors and the corresponding crosstalk coefficients of the respective crosstalk detectors. The crosstalk amounts corresponding to the respective crosstalk detectors are accumulated to determine the total crosstalk amount. In such a case, the accuracy of the determined total crosstalk amount can be enhanced. Moreover, this calculation method is simple and easy to implement.

Furthermore, the determined crosstalk coefficient can reflect a crosstalk level of the crosstalk detector to the target detector more accurately by setting the crosstalk coefficients to be related to the distances between the crosstalk detectors and the target detector. In such a case, the accuracy of calculating the determined total crosstalk amount can be enhanced.

Furthermore, the obstacle distances are determined based on the output signal of the target detector and the output signals of the respective crosstalk detectors. When it is determined that a difference between an obstacle distance corresponding to a respective crosstalk detector and the obstacle distance corresponding to the target detector exceeds the predetermined distance threshold, the crosstalk detector and the target detector do not detect the same obstacle. The crosstalk detector causes less crosstalk to the target detector. In such a case, the crosstalk coefficient of the corresponding crosstalk detector can be set to zero. In such a case, the accuracy of the determined crosstalk amount can be enhanced.

Furthermore, whether the actual detection signal is the valid signal can be determined by determining whether the signal intensity of the actual detection signal exceeds the predetermined detection threshold. Moreover, in response to determining that the actual detection signal is the valid signal, information related to obstacles can be determined. And in response to determining that the actual detection signal is an invalid signal, the actual detection signal can be marked. In such a case, the accuracy of point cloud data can be enhanced.

### BRIEF DESCRIPTION OF THE DRAWINGS

To describe technical solutions of embodiments of this disclosure more clearly, drawings to be used in the embodiments of this disclosure or in the description of the prior art will be briefly introduced below, and it is apparent that the drawings described below are merely some of the embodiments of this disclosure, and that other drawings may also be determined based on these drawings for those ordinary skilled in the art without creative labor.

FIG. 1 illustrates a schematic diagram of blooming of a high-reflectivity object.

FIG. 2 illustrates a structural schematic diagram of a receiving end of a LiDAR.

FIG. 3 illustrates a flowchart of a signal processing method for a LiDAR, consistent with some embodiments of this disclosure.

FIG. 4 illustrates a flowchart of determining a total crosstalk amount caused by respective crosstalk detectors to a target detector, consistent with some embodiments of this disclosure.

FIG. 5 illustrates a schematic diagram of distribution of receiving field of view of a detector, consistent with some embodiments of this disclosure.

FIG. 6 illustrates a structural schematic diagram of a signal processor apparatus for a LiDAR, consistent with some embodiments of this disclosure.

FIG. 7a illustrates a diagram of point cloud data distribution based on an existing detection solution.

FIG. 7b illustrates a diagram of point cloud data distribution after crosstalk removal processing, consistent with some embodiments of this disclosure.

FIG. 8 illustrates a structural schematic diagram of a LiDAR, consistent with some embodiments of this disclosure.

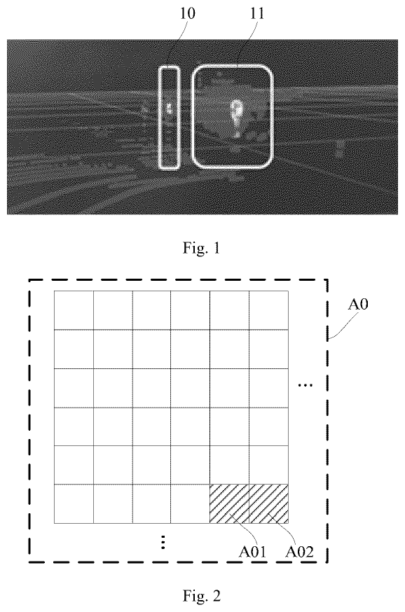

### DETAILED DESCRIPTION

To make those skilled in the art better understand problems existing in the prior art, firstly, a principle of crosstalk caused to a LiDAR is briefly introduced combined with a structure of the LiDAR.

FIG. 2 illustrates a structural schematic diagram of a receiving end of a LiDAR. As shown in FIG. 2, the receiving end of the LiDAR includes photosensitive area A0 of a two-dimensional detector array. The two-dimensional detector array includes multiple detectors arranged in an array.

When the LiDAR is detecting, multiple detectors (e.g., a detector A01 and a detector A02 shown in FIG. 2) can work in parallel. When a detector detects a high-reflectivity obstacle, an intensity of an echo signal is very high. In addition to receiving the echo signal detected by itself, each detector can also cause crosstalk to other detectors around it. That is, each detector can receive not only an echo signal corresponding to an obstacle detected by itself, but also crosstalk signals caused by all detectors that can cause the crosstalk to it (e.g., the detector A01 can receive both an echo signal detected by itself and a crosstalk signal caused by the detector A02 to it). In such a case, a final signal received by each detector is a result of combined effect of all detectors within an entire receiving field of view.

However, it is known from the content of BACKGROUND that when a detector in the LiDAR causes the crosstalk, it is easy to form blooming or broadening in point cloud. In such a case, quality of the point cloud can be affected.

For the LiDAR including multiple detectors, the crosstalk between each detector of the LiDAR needs to be reduced. In embodiments of this disclosure, after a target detector is selected, a total crosstalk amount caused by other detectors on the target detector can be determined. Then, an actual detection signal of the target detector can be determined based on a determined output signal of the target detector and the total crosstalk amount. That is, using the above signal processing method, the total crosstalk amount caused by other detectors to the target detector can be eliminated. In such a case, the actual detection signal of the target detector does not include crosstalk amounts caused by other detectors. Accordingly, an influence of the crosstalk between the multiple detectors on a detection result can be eliminated. Noise points generated by the crosstalk can be eliminated. And the quality of the point cloud can be improved.

Signal processing solutions for the LiDAR in the embodiments of this disclosure are described in detail below, respectively. In such a case, those skilled in the art can better understand inventive concepts, working principles, and advantages of the embodiments of this disclosure.

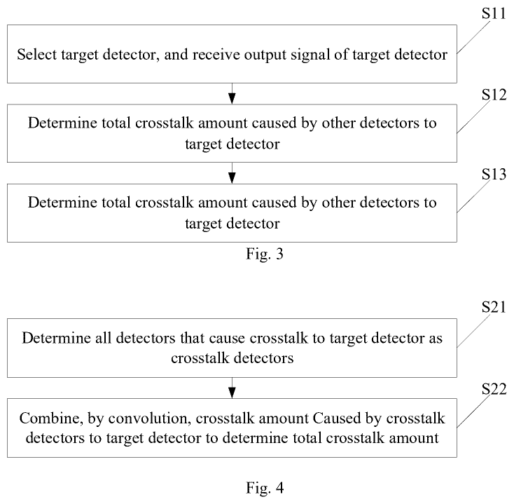

For a LiDAR including multiple detectors, when detectors in the LiDAR work in parallel, the crosstalk can occur between the detectors. Refer to a flowchart of a signal processing method for a LiDAR, consistent with embodiments of this disclosure, shown in FIG. 3. To reduce the crosstalk between the detectors in the LiDAR, in some embodiments of this disclosure, an output signal of respective detectors can be processed based on the following steps.

At S11, a target detector is selected. An output signal of the target detector is determined.

In some embodiments, a photodetector can be selected as a detector in the LiDAR.

In some embodiments, the photodetector can be an avalanche photodiode (APD), a single photon avalanche diode (SPAD), a silicon photomultiplier (SiPM), or other photodetectors. The embodiments of this disclosure do not limit a specific structure of the detector, as long as it can perform photoelectric conversion on a received light signal to determine a corresponding output signal.

To reduce the crosstalk between the detectors, any one or more of the multiple detectors can be selected as the target detector to process the output signal of the target detector. Or a detector that meets predetermined conditions can be selected from the multiple detectors. Then, output signals of detectors that meet the predetermined conditions can be processed in sequence based on working sequence of the detectors. The embodiments of this disclosure do not limit selection of the target detector, as long as the output signal of the detector can be determined.

In some embodiments, the output signal can be a signal related to obstacle information detected by the target detector. In some embodiments, the output signal can include a signal output by the target detector itself and a crosstalk signal caused by other detectors to the target detector.

At S12, a total crosstalk amount caused by other detectors to the target detector is determined.

In some embodiments, for a selected target detector, a crosstalk amount caused by other detectors to the target detector can be determined. Further, the total crosstalk amount caused by other detectors to the target detector can be calculated.

At S13, an actual detection signal of the target detector is determined based on an output signal of the target detector and the total crosstalk amount.

In some embodiments, the actual detection signal of the target detector can be determined using a predetermined calculation method based on the output signal of the target detector and the total crosstalk amount.

In some embodiments, the actual detection signal of the target detector can be determined by subtracting the total crosstalk amount from the output signal of the target detector. That is, a difference between the output signal of the target detector and the total crosstalk amount is determined as the actual detection signal of the target detector.

It can be understood that the above calculation method is for an illustrative purpose only. The embodiments of this disclosure do not limit a specific calculation method for determining the actual detection signal of the target detector, as long as the actual detection signal of the target detector can be determined based on the output signal of the target detector and the total crosstalk amount.

In such a case, using the signal processing method for the LiDAR in the embodiments of this disclosure, the total crosstalk amount caused by other detectors to the target detector can be eliminated. In such a case, the actual detection signal of the target detector does not include the crosstalk amounts caused by other detectors. Accordingly, the influence of the crosstalk between the detectors on the detection result can be eliminated. The noise points can be eliminated. The quality of the point cloud can be improved.

The following provides some exemplary examples of exemplary implementation manners of the signal processing solutions for the LiDAR in the embodiments of this disclosure. In such a case, those skilled in the art can better understand and implement solutions in the embodiments of this disclosure.

In an actual working process, inventors found that if the detector detects an ordinary obstacle (which can be understood as an object with low reflectivity, e.g., an object with reflectivity lower than a first reflectivity threshold), energy of an echo signal detected by the detector is weak, and a crosstalk amount caused to other detectors can be small and ignored. In such a case, it will not affect output signals of other detectors. Accordingly, in some embodiments of this disclosure, the output signal of the detector can be processed to eliminate the crosstalk when it is determined that the detector detects a high-reflectivity obstacle (e.g., an object with the reflectivity higher than a second reflectivity threshold, which can be higher than or equal to the first reflectivity threshold).

Based on this, in the exemplary implementations, whether the output signal of the detector is a high-reflectivity echo signal can be determined. When it is determined that the output signal is the high-reflectivity echo signal, the detector is selected as the target detector.

By using the above determination method, only the detector whose output signal is the high-reflectivity echo signal can be processed. In such a case, the computational load can be reduced and processing efficiency can be improved.

In some embodiments, when the target detector detects the high-reflectivity obstacle, an echo light signal received by the target detector is very strong. In such a case, the output signal exhibits signal characteristics corresponding to a strong echo. Accordingly, whether the output signal of the detector is the high-reflectivity echo signal can be determined based on signal characteristics of the output signal of the detector. A determination process is simple and easy to implement.

In some embodiments of this disclosure, the signal characteristics of the output signal include at least one of a noise value, an intensity value, a pulse width of echo waveform, or a slope of the echo waveform.

It should be noted that types of the signal characteristics of the output signal mentioned above are for the illustrative purpose only. In some other embodiments, the signal characteristics of the output signal can also include a photon number, an integral value, or the like. The embodiments of this disclosure do not limit this, as long as it can be determined whether the output signal is the high-reflectivity echo signal based on the signal characteristics.

For ease of understanding, the following provides exemplary examples to illustrate in detail how to determine whether the output signal is the high-reflectivity echo signal based on the signal characteristics of the output signal.

Example 1: Whether the output signal of the detector is a high-reflectivity signal is determined based on a relative relationship between a noise value of the output signal of the detector and a predetermined noise threshold. Details are presented below.

When it is determined that the noise value of the output signal of the detector is lower than the predetermined noise threshold, it indicates that the detector has not detected the high-reflectivity obstacle. The output signal is not a high-reflectivity echo signal.

When it is determined that the noise value of the output signal of the detector is higher than the predetermined noise threshold, it indicates that the detector has detected the high-reflectivity obstacle. The output signal is the high-reflectivity echo signal.

In an exemplary example, the predetermined noise threshold can be determined based on baseline noise of the output signal of the detector.

Example 2: The reflectivity of the high-reflectivity obstacle can be much higher than the reflectivity of the ordinary object. In such a case, for detection signals with the same emitted intensity, an output signal of a detector corresponding to a high-reflectivity obstacle echo is significantly stronger than that corresponding to a normal obstacle echo. Accordingly, whether the output signal of the detector is the high-reflectivity echo signal can be determined based on the signal intensity.

In exemplary embodiments, when it is determined that an intensity corresponding to the output signal is higher than a predetermined intensity threshold, it indicates that the detector has detected the high-reflectivity obstacle. The output signal is the high-reflectivity echo signal. The detector can be selected as the target detector. Further, the output signal of the detector can be processed to eliminate the crosstalk. When it is determined that the intensity corresponding to the output signal is lower than the predetermined intensity threshold, it indicates that the detector has not detected the high-reflectivity obstacle. The output signal is not the high-reflectivity echo signal. There is no need to process the output signal of the detector to eliminate the crosstalk.

In other embodiments, whether the output signal is the high-reflectivity echo signal can be determined based on a corresponding relationship between other characteristics of the echo waveform and echo signals of obstacles with different reflectivity received by the detector. In some exemplary examples, whether the output signal is the high-reflectivity echo signal can be determined based on a relationship between the pulse width of the echo waveform and a predetermined pulse width, or a relationship between the slope of the echo waveform and a predetermined slope. Moreover, when it is determined that the output signal is the high-reflectivity echo signal, the output signal of the detector can be processed to eliminate the crosstalk.

It should be noted that the above determination methods are for the illustrative purpose only. In exemplary embodiments, based on actual needs, whether the output signal is the high-reflectivity echo signal can also be determined by determining a relationship between an integrated value of the output signal within a predetermined time period and a predetermined integrated value. The embodiments of this disclosure do not limit this.

In some other embodiments, at least two parameters from the noise value, the intensity value, the pulse width of the echo waveform, or the slope of the echo waveform can be combined to determine whether the output signal of the detector is the high-reflectivity echo signal. In such a case, the accuracy of determination can be improved.

In some embodiments, when it is determined that the output signal is the high-reflectivity echo signal, the corresponding detector can be selected as the target detector. Then, detectors that cause crosstalk to the target detector can be determined. Further, the total crosstalk amount caused to the target detector can be determined.

Referring to FIG. 4, it illustrates a flowchart of determining a total crosstalk amount caused by respective crosstalk detectors to a target detector, consistent with some embodiments of this disclosure. As shown in FIG. 4, in some embodiments of this disclosure, the total crosstalk amount can also be determined based on the following steps.

At a step S21, all detectors that cause crosstalk to the target detector are determined as crosstalk detectors.

In some embodiments, after determining the target detector, it should be considered that not all detectors will cause crosstalk to the target detector. For example, if a detector detects a normal obstacle or if the detector is far away from the target detector, it cannot be able to cause the crosstalk to the target detector. In such a case, which detectors will cause crosstalk to the target detector need to be determined before determining the total crosstalk amount.

In some embodiments of this disclosure, all detectors that cause crosstalk to the target detector can be determined based on distribution of receiving field of view (a point spread function) of the target detector.

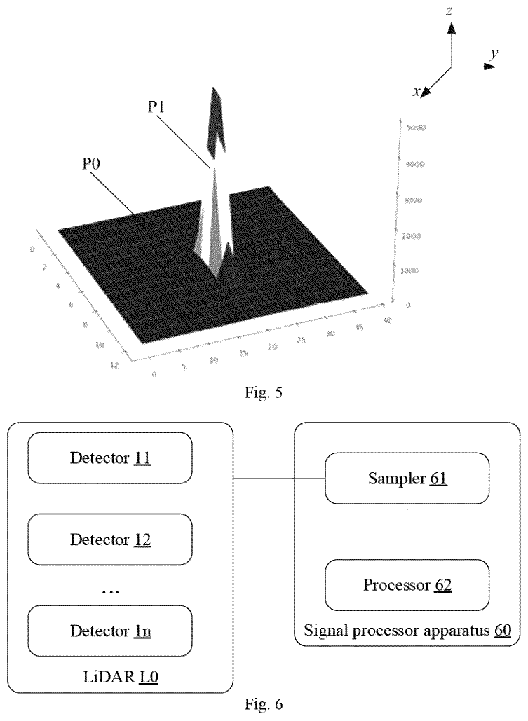

For example, referring to FIG. 5, it illustrates a schematic diagram of distribution of receiving field of view of a target detector, consistent with some embodiments of this disclosure. A plane P0 represents a detector array. Each rectangular grid represents a detector. The detector array can include multiple detectors. An x-axis and a y-axis represent a position of each detector. A relative position of each detector can be determined through the x-axis and the y-axis. A z-axis represents a signal intensity value of each detector. A pulse pattern P1 represents a point spread function of the target detector. The point spread function can be used to characterize crosstalk capability of other detectors to the target detector, or to characterize reception capability of the target detector to signals from different positions.

In some embodiments, when target detectors are determined, for example, detectors with coordinates (19,20), (6,7) in FIG. 5, all detectors that cause crosstalk to them can be determined based on their corresponding point spread function. For example, detectors covered by intersection of the pulse pattern P1 and the plane P0 in FIG. 5 can be determined as the crosstalk detectors.

In some other embodiments, when the target detectors are determined, detectors within a certain range around them can be determined as the crosstalk detectors.

In some other embodiments, when the target detectors are determined, other detectors can all be determined as the crosstalk detectors.

In some embodiments of this disclosure, to reduce computational difficulty, respective target detector can use the same point spread function. That is, the point spread function for each detector in a two-dimensional detector array can be assumed to be identical. In some other embodiments, the point spread function of respective target detectors can be determined. The crosstalk detectors that cause the crosstalk to the respective target detectors can be determined. In such a case, the accuracy of the determined actual detection signal of the target detector can be enhanced.

It should be noted that the distribution of receiving field of view of the detector shown in FIG. 5 is for the illustrative purpose only. For different application scenarios, distribution of field of view corresponding to each detector can be different. The embodiments of this disclosure do not limit this, as long as the distribution of field of view of the detector can be established.

At a step S22, convolution is performed on crosstalk amounts caused by crosstalk detectors to the target detector, to determine the total crosstalk amount.

In some embodiments, when all detectors that can cause the crosstalk to the target detector are determined, the crosstalk amounts of the respective crosstalk detectors to the target detector can be calculated. Moreover, respective crosstalk amounts can be convolved to determine the total crosstalk amount.

The output signal of the target detector is a result of combined effect of the target detector itself and all crosstalk detectors. The total crosstalk amount determined by combining the crosstalk amounts caused by the crosstalk detectors to the target detector by convolution can reflect the crosstalk caused by all crosstalk detectors to the target detector more accurately. In such a case, the accuracy of the determined actual detection signal of the target detector can be enhanced.

In some embodiments of this disclosure, the step S21 can exemplarily include the following.

At a step C1, output signals of respective crosstalk detectors are determined. Crosstalk amounts corresponding to the respective crosstalk detectors are determined based on crosstalk coefficients corresponding to the respective crosstalk detectors.

In some embodiments, the crosstalk amounts of the respective crosstalk detectors to the target detector can be determined by using a predetermined calculation method based on the output signals and the crosstalk coefficients of the respective crosstalk detectors.

In some embodiments, products of the crosstalk coefficients corresponding to the respective crosstalk detectors and signal intensities of the output signals are determined as the crosstalk amounts corresponding to the respective crosstalk detectors.

It can be understood that the above calculation method is for the illustrative purposes only. The embodiments of this disclosure do not limit a specific calculation method for determining the crosstalk amounts corresponding to the respective crosstalk detectors, as long as the crosstalk amount can be determined based on the crosstalk coefficient corresponding to the crosstalk detector and the signal intensity of the output signal of the crosstalk detector.

At a step C2, the crosstalk amounts corresponding to the respective crosstalk detectors are accumulated to determine the total crosstalk amount.

Furthermore, the crosstalk amounts caused by the respective crosstalk detectors to the target detector can be determined at the step C1. Respective crosstalk amounts can be accumulated to determine the total crosstalk amount from respective crosstalk detectors to the target detector. In such a case, the accuracy of the determined total crosstalk amount can be enhanced. Moreover, the calculation method is simple and easy to implement.

In some embodiments, the inventors conducted further research on factors affecting the crosstalk coefficient and found that the crosstalk coefficients are related to the distances between the crosstalk detectors and the target detector.

For example, continuously referring to FIG. 5, it can be seen from FIG. 5 that the target detector has a stronger reception capability for signals that are closer to it. Accordingly, the closer the crosstalk detector is to the target detector, the stronger the crosstalk signal it causes to the target detector, and the larger its corresponding crosstalk coefficient. Conversely, crosstalk detectors farther away from the target detector cause weaker crosstalk to the target detector, with smaller corresponding crosstalk coefficients. Some crosstalk detectors can even cause a relative crosstalk intensity value of zero to the target detector, and thus have a crosstalk coefficient of zero.

That is, the crosstalk coefficients are negatively correlated with the distances between the crosstalk detectors and the target detector. The farther the distances between the crosstalk detectors and the target detector, the smaller the crosstalk coefficients. The closer the distances between the crosstalk detectors and the target detector, the larger the crosstalk coefficients. In such a case, by setting the crosstalk coefficients to be related to the distances between the crosstalk detectors and the target detector, the determined crosstalk coefficients can reflect a crosstalk level of the respective crosstalk detectors to the target detector more accurately. Accordingly, the accuracy of the determined total crosstalk amount can be enhanced.

As another exemplary example, the distribution of receiving field of view of the target detector is determined by testing. The crosstalk coefficients of the respective crosstalk detectors are determined based on the distribution of receiving field of view. Referring to FIG. 5, based on the distribution of receiving field of view, if the signal intensity of the target detector itself is 5500, and the signal intensity corresponding to a crosstalk detector is 4500, the crosstalk coefficient of the crosstalk detector to the target detector can be 4500/5500≈0.818.

The following provides an exemplary example to illustrate an exemplary process of the signal processing method in the embodiments of this disclosure. In such a case, those skilled in the art can better understand the signal processing method in the embodiments of this disclosure.

When multiple detectors of the LiDAR work in parallel, the output signal corresponding to each detector can be determined. When the output signal of any one of the multiple detectors is determined to be the high-reflectivity echo signal, the detector can be selected as the target detector.

Then, the distribution of receiving field of view of the target detector is determined (refer to FIG. 5). All detectors that cause the crosstalk to the target detector can be determined and selected as the crosstalk detectors based on the point spread function of the target detector. Further, the crosstalk coefficients corresponding to the respective crosstalk detectors can be determined based on relative signal intensity between the crosstalk detectors and the target detector.

The products of the crosstalk coefficients corresponding to the respective crosstalk detectors and the signal intensities of the output signals can be calculated. Respective crosstalk amounts caused by the respective crosstalk detectors to the target detector can be determined. And the respective crosstalk amounts can be accumulated to determine the total crosstalk amount caused by respective crosstalk detectors to the target detector.

Finally, the total crosstalk amount can be subtracted from the output signal of the target detector. That is, the actual detection signal can be determined. Information related to the obstacles can be determined based on the actual detection signal.

In the above-described signal processing process, the total crosstalk is determined under the condition that both the target detector and the crosstalk detectors detect the high-reflectivity obstacle. The crosstalk detectors receive strong echoes reflected from the high-reflectivity obstacle. Accordingly, the crosstalk detectors cause the crosstalk to the target detector. In practical operation, some crosstalk detectors cannot detect the high-reflectivity obstacle. In such a case, the crosstalk caused by the crosstalk detectors is very small and can be ignored.

Based on this, in some embodiments of this disclosure, after determining a crosstalk detector, a crosstalk coefficient of the crosstalk detector can also be determined by a difference between an obstacle distance corresponding to the crosstalk detector and an obstacle distance corresponding to the target detector.

In an exemplary example, obstacle distances can be determined based on the output signal of the target detector and the output signals of the respective crosstalk detectors. When the difference between an obstacle distance corresponding to the respective crosstalk detector and an obstacle distance corresponding to the target detector exceeds a predetermined distance threshold, the crosstalk coefficient of the respective crosstalk detector is set to zero.

In some embodiments, when the difference between the obstacle distance corresponding to the respective crosstalk detector and the obstacle distance corresponding to the target detector is determined to exceed the predetermined distance threshold, it indicates that the crosstalk detector and the target detector have not detected the same obstacle. It can also be considered that the crosstalk detector has not detected the high-reflectivity obstacle. That is, the crosstalk detector has not received the high-reflectivity echo. In such a case, the crosstalk detector can cause lower crosstalk to the target detector. In such a case, the crosstalk coefficient of the corresponding crosstalk detector can be set to zero. In such a case, the accuracy of the determined crosstalk amount can be enhanced.

It can be understood that when the difference between the obstacle distance corresponding to the respective crosstalk detector and the obstacle distance corresponding to the target detector does not exceed the predetermined distance threshold, the crosstalk coefficient corresponding to the respective crosstalk detector can still be determined based on the point spread function of the target detector.

In some embodiments of this disclosure, the predetermined distance threshold can be flexibly set based on the actual needs. For example, in some scenarios with high precision requirements, the predetermined distance threshold can be a smaller value or a smaller interval value. In some scenarios with low precision requirements, the predetermined distance threshold can be a larger value or a larger interval value. The embodiments of this disclosure do not limit this.

In some embodiments, the predetermined distance threshold can be 10 cm.

In some embodiments, the output signal of the target detector is the result of combined effect of itself and all crosstalk detectors. A target detector may not detect an obstacle. The output signal of the target detector is the crosstalk caused by the respective crosstalk detectors. In such a case, after the actual detection signal of the target detector is determined by using the above method, whether the signal intensity of the actual detection signal exceeds a predetermined detection threshold can be determined to determine whether the actual detection signal is a valid signal.

In some embodiments, when it is determined that the signal intensity of the actual detection signal exceeds the predetermined detection threshold, it indicates that the actual detection signal is the valid signal. The target detector detects the obstacle. Further, the information related to the obstacle can be determined based on the actual detection signal. When the signal intensity of the actual detection signal does not exceed the predetermined detection threshold, it indicates that the target detector may not receive an obstacle echo. The output signal of the target detector is a result of the crosstalk caused by the crosstalk detectors to the target detector. In such a case, the actual detection signal is determined to be an invalid signal.

Furthermore, the actual detection signal determined as the invalid signal can be marked. For example, corresponding data points can be filtered out from the point cloud data, or the corresponding data points can be marked as untrusted data in the point cloud data. In such a case, the accuracy of the point cloud data can be enhanced. In an exemplary example, after processing the target detector, other detectors can be determined or processed, respectively. In some embodiments, in a certain order, all detectors that perform detection can be determined, respectively. When it is determined that the detector detects the high-reflectivity obstacle, further processing can be performed to eliminate the crosstalk. Accordingly, the noise points can be reduced and the quality of the point cloud can be improved.

It should be noted that the signal processing method provided in the embodiments of this disclosure is not limited to application of a two-dimensional detector array. For a linear detector array or other forms of detectors, as long as there are multiple detectors detecting in parallel, the signal processing method provided in the embodiments of this disclosure can be used to eliminate the crosstalk on the target detector.

The embodiments of this disclosure further provide a signal processor apparatus corresponding to the above signal processing method. The following will provide a detailed introduction through exemplary embodiments with reference to accompanying drawings. It should be noted that the signal processor apparatus described below can be considered as a functional module required to implement the signal processing method provided by this disclosure. The content of the signal processor apparatus described below can be cross referenced with the content of the signal processing method described above.

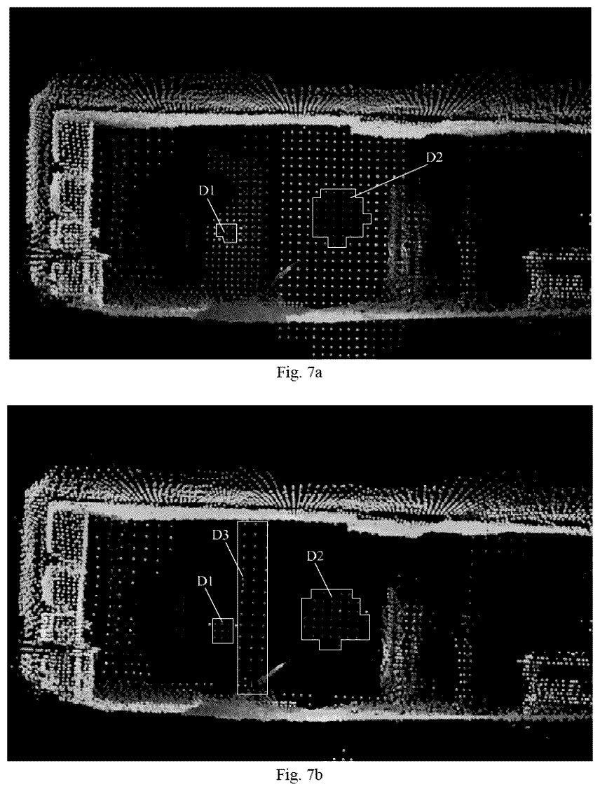

Referring to FIG. 6, it illustrates a signal processor apparatus for a LiDAR, consistent with some embodiments of this disclosure. A LiDAR L0 includes multiple detectors 11 to 1n. And n is an integer greater than 1.

In some embodiments of this disclosure, the detector can be a photodetector. In some embodiments, the photodetector can be an avalanche photodiode (“APD”), a single photon avalanche photodiode (“SPAD”), a silicon photomultiplier tube (“SiPM”), or other photodetectors.

A signal processor apparatus 60 include a sample 61 and a processor 62.

The sampler 61 can receive an output signal of a target detector.

The processor 62 can determine a total crosstalk amount caused by other detectors to the target detector. The processor 62 can determine an actual detection signal of the target detector based on the output signal of the target detector and the total crosstalk amount.

In some embodiments, for the LiDAR L0 including multiple detectors, after determining the target detector, the processor 62 can determine the total crosstalk amount caused by other detectors to the target detector. Then, the processor 62 can determine the actual detection signal of the target detector based on the output signal of the target detector determined by the sampler 61 and the total crosstalk amount. In such a case, the total crosstalk amount caused by other detectors to the target detector can be eliminated. The actual detection signal of the target detector does not include crosstalk amounts caused by other detectors. Accordingly, an influence of crosstalk between each detector on a detection result can be eliminated. Noise points generated by the crosstalk can be eliminated. The quality of point cloud can be improved.

It should be noted that any one or more of the multiple detectors can be selected as the target detector to process the output signals of the respective target detectors. Or a detector that meets a predetermined condition can be selected from the multiple detectors. Output signals of detectors that meet the predetermined condition may be processed in sequence based on working sequence of the detectors. The embodiments of this disclosure do not limit selection of the target detector, as long as the output signal of the detector can be determined.

In practical operation, inventors found that if the detector detects a normal obstacle (which can be understood as an object with low reflectivity, e.g., an object with reflectivity lower than a first reflectivity threshold), energy of an echo signal detected by the detector is weak. The crosstalk amount caused to other detectors are small and can be ignored. Accordingly, it will not affect output signals of other detectors. In such a case, in some embodiments of this disclosure, the output signal of the detector can be processed to eliminate the crosstalk when it is determined that the detector detects a high-reflectivity obstacle (e.g., an object with the reflectivity higher than a second reflectivity threshold, which can be greater than or equal to the first reflectivity threshold).

Based on this, during the exemplary implementation, the processor can determine whether the output signal of the detector is a high-reflectivity echo signal. When it is determined that the output signal is the high-reflectivity echo signal, the detector is used as the target detector. An exemplary determination process can be referred to in the aforementioned content, and will not be further elaborated herein.

During an actual processing process, after determining the target detector, it should be considered that not all detectors can cause crosstalk to the target detector. For example, if the detector detects a normal object or if the detector is far away from the target detector, it may not be able to cause the crosstalk to the target detector. In such a case, which detectors can cause the crosstalk to the target detector need to be determined. And the detectors are determined as crosstalk detectors before determining the total crosstalk amount. Further, only the crosstalk amount of the respective crosstalk detectors to the target detector needs to be determined.

In some embodiments of this disclosure, the processor can determine all detectors that cause the crosstalk to the target detector and use them as the crosstalk detectors. Moreover, convolution is performed on the crosstalk amount caused by the crosstalk detector to the target detector to determine the total crosstalk amount.

In an exemplary example, the processor can determine all detectors that cause the crosstalk to the target detector based on distribution of receiving field of view (a point spread function) of the target detector. An exemplary process can be referred to in the above-described content.

In some other examples, when the target detector is determined, detectors within a certain range around it can be determined as the crosstalk detectors.

In some other embodiments, when the target detector is determined, other detectors can also be determined as the crosstalk detectors.

In some embodiments of this disclosure, to reduce computational difficulty, the respective target detectors can use the same point spread function. That is, the distribution of receiving field of view of each detector in a two-dimensional detector array can be assumed to be identical. In some other embodiments, the point spread function of respective target detectors can be determined. The crosstalk detectors that cause the crosstalk to the respective target detectors can be determined. In such a case, accuracy of the determined actual detection signal of the target detector can be enhanced.

In some embodiments, the processor can receive the output signals of the respective crosstalk detectors, and determine the crosstalk amounts corresponding to the respective crosstalk detectors based on the crosstalk coefficients corresponding to the respective crosstalk detectors. Moreover, the processor can accumulate the crosstalk amounts corresponding to the respective crosstalk detectors to determine the total crosstalk amount.

In some embodiments, the processor can determine products of the crosstalk coefficients corresponding to the respective crosstalk detectors and signal intensities of the output signals as the crosstalk amounts corresponding to the respective crosstalk detectors. Then, each crosstalk amount can be accumulated to enhance the accuracy of the determined total crosstalk amount of respective crosstalk detectors to the target detector. Moreover, the calculation method is simple and easy to implement.

In some embodiments, the inventors conducted further research on factors affecting the crosstalk coefficients and found that the crosstalk coefficients are related to the distances between the crosstalk detectors and the target detector.

Furthermore, as shown in FIG. 5, t the target detector has a stronger reception capability for signals that are closer to it. Accordingly, the closer the crosstalk detector is to the target detector, the stronger the crosstalk signal it causes to the target detector, and the larger its corresponding crosstalk coefficient. Conversely, crosstalk detectors farther away from the target detector cause weaker crosstalk to the target detector, with smaller corresponding crosstalk coefficients. That is, the crosstalk coefficients are negatively correlated with the distances between the crosstalk detectors and the target detector. In such a case, by setting the crosstalk coefficients to be related to the distances between the crosstalk detectors and the target detector, the determined crosstalk coefficients can reflect a crosstalk level of the respective crosstalk detectors to the target detector more accurately. Accordingly, the accuracy of the determined total crosstalk amount can be enhanced.

In some embodiments, the processor can determine the actual detection signal of the target detector by using a predetermined calculation method based on the output signal of the target detector and the total crosstalk amount.

In some embodiments, the processor can subtract the total crosstalk amount from the output signal of the target detector to determine the actual detection signal of the target detector. That is, a difference between the output signal of the target detector and the total crosstalk amount can be determined as the actual detection signal of the target detector.

The following provides an exemplary example to illustrate an exemplary process of the signal processor apparatus in the embodiments of this disclosure. In such a case, those skilled in the art can better understand a working principle of the signal processor apparatus in the embodiments of this disclosure.

When multiple detectors of the LiDAR work in parallel, the sampler can receive the output signal corresponding to each detector. When the processor determines that the output signal of any one of the multiple detectors is the high-reflectivity echo signal, the detector can be selected as the target detector.

Then, the processor can determine the point spread function of the target detector. Moreover, all detectors that cause crosstalk to the target detector can be determined and selected as the crosstalk detectors based on the point spread function of the target detector. Further, the crosstalk coefficients corresponding to the respective crosstalk detectors can be determined based on relative signal intensity between the crosstalk detectors and the target detector.

Afterwards, the processor can calculate the products of the crosstalk coefficients corresponding to the respective crosstalk detectors and the signal intensities of the output signals. The crosstalk amount caused by the respective crosstalk detectors to the target detector can be determined. And respective crosstalk amounts can be accumulated to determine the total crosstalk amount caused by respective crosstalk detectors to the target detector.

Finally, the processor subtracts the total crosstalk amount from the output signal of the target detector. That is, the actual detection signal can be determined. Information related to obstacles can be determined based on the actual detection signal.

In the above signal processing process, on the total crosstalk is determined under the condition that both the target detector and the crosstalk detector detect the high-reflectivity obstacle. The crosstalk detectors receive strong echoes reflected from the high-reflectivity obstacle. Accordingly, the crosstalk detectors cause the crosstalk to the target detector. In practical operation, some crosstalk detectors cannot detect the high-reflectivity obstacle. In such a case, the crosstalk caused by the crosstalk detectors is very small and can be ignored.

Based on this, in some embodiments of this disclosure, after the processor determines a crosstalk detector, a crosstalk coefficient of the crosstalk detector can also be determined by a difference between an obstacle distance corresponding to a respective crosstalk detector and an obstacle distance corresponding to the target detector.

In an exemplary example, the processor can also determine obstacle distances based on the output signal of the target detector and the output signals of the respective crosstalk detectors. When the difference between the obstacle distance corresponding to a respective crosstalk detector and the obstacle distance corresponding to the target detector exceeds a predetermined distance threshold, a crosstalk coefficient of the respective crosstalk detector is set to zero.

In some embodiments, when the processor determines that the difference between the obstacle distance corresponding to the respective crosstalk detector and the obstacle distance corresponding to the target detector exceeds the predetermined distance threshold, it indicates that the crosstalk detector and the target detector have not detected the same obstacle. It can also be considered that the crosstalk detector has not detected the high-reflectivity obstacle. That is, the crosstalk detector has not received the high-reflectivity echo. In such a case, the crosstalk detector can cause lower crosstalk to the target detector. In such a case, the crosstalk coefficient of the corresponding crosstalk detector can be set to zero. In such a case, the accuracy of the determined crosstalk amount can be enhanced.

It can be understood that when the difference between the obstacle distance corresponding to the respective crosstalk detector and the obstacle distance corresponding to the target detector does not exceed the predetermined distance threshold, the processor can still determine the crosstalk coefficient corresponding to the respective crosstalk detectors based on the point spread function of the target detector.

In some embodiments of this disclosure, the predetermined distance threshold can be flexibly set based on actual needs. In some embodiments, the predetermined distance threshold can be 10 cm.

In some embodiments, the output signal of the target detector is the result of combined effect of itself and all crosstalk detectors. A target detector may not detect an obstacle. The output signal of the target detector is the crosstalk caused by the respective crosstalk detectors. In such a case, after the actual detection signal of the target detector is determined by using the above method, whether the signal intensity of the actual detection signal exceeds a predetermined detection threshold can also be determined to determine whether the actual detection signal is a valid signal.

In some embodiments, when the processor determines that the signal intensity of the actual detection signal exceeds the predetermined detection threshold, it indicates that the actual detection signal is the valid signal. The target detector detects the high-reflectivity obstacle. Further, the information related to the obstacles can be determined based on the actual detection signal. When the processor determines that the signal intensity of the actual detection signal does not exceed the predetermined detection threshold, it indicates that the actual detection signal is an invalid signal. The output signal of the actual detection signal is a result of the crosstalk caused by the crosstalk detectors to the actual detection. In such a case, the actual detection signal is determined to be the invalid signal.

Furthermore, the processor can mark the actual detection signal that is determined as the invalid signal. For example, corresponding data points can be filtered out from point cloud data, or the corresponding data points can be marked as untrusted data in the point cloud data. Accordingly, the accuracy of the point cloud data can be enhanced.

In some embodiments, the sampler can be implemented through a sampler circuit, an application specific integrated circuit (“ASIC”), or one or more integrated circuits configured in the embodiments of this disclosure. It can also be implemented through processing chips such as a central processing unit (“CPU”), a field programmable gate array (“FPGA”), or the like.

The processor can be implemented through the processing chips such as the central processing unit (“CPU”), the field programmable gate array (“FPGA”), or through the application specific integrated circuit (“ASIC”) or one or more integrated circuits configured to implement the embodiments of this disclosure.

In some embodiments of this disclosure, the above signal processor apparatus and the LiDAR can be applied to corresponding equipment. For example, the signal processor apparatus and the LiDAR can be applied to a vehicle. During operation of the vehicle, the LiDAR can detect surrounding environment and output a corresponding signal. The signal processor apparatus can process the output signal to improve the quality of point cloud.

Referring to FIG. 7a and FIG. 7b, FIG. 7a illustrates a diagram of point cloud data distribution based on an existing detection solution. FIG. 7b illustrates a diagram of point cloud data distribution after crosstalk removal processing, consistent with some embodiments of this disclosure. A region D1 and a region D2 in FIG. 7a are point cloud data of the high-reflectivity obstacle (e.g., a road sign) detected by the target detector. It can be seen from FIG. 7a that there are many noise points generated by the crosstalk detector around D1 and D2.

When using a signal processing solution in the embodiments of this disclosure, as shown in FIG. 7b, the number of noise points around the region D1 and the region D2 is significantly reduced. The crosstalk between each detector has been basically eliminated. Accordingly, the quality of the point cloud has been improved.

It should be noted that when multiple detectors work in parallel, if the detector does not detect the high-reflectivity obstacle or is far away from the target detector, it may not cause crosstalk to the target detector or the crosstalk caused is very small. In such a case, when processing the output signal of the target detector, there is no need to consider the crosstalk amount caused by the detector. Data points detected by the detector can be retained in a point cloud map. For example, as shown in FIG. 7b, data points in a region D3 are not eliminated.

The embodiments of this disclosure further provide a LiDAR. The following provides a detailed description through exemplary examples with reference to the accompanying drawings.

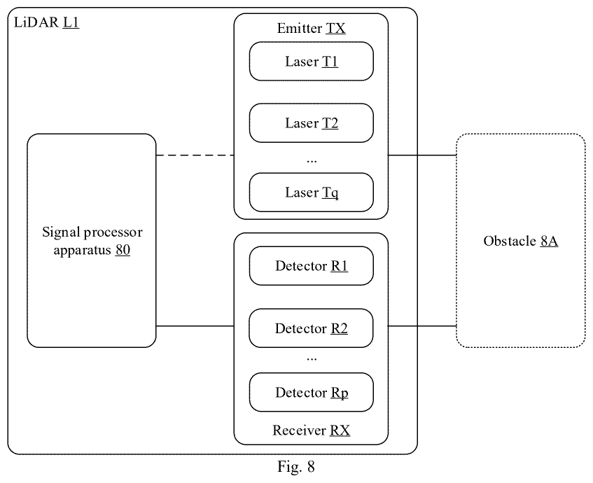

FIG. 8 illustrates a structural schematic diagram of a LiDAR, consistent with some embodiments of this disclosure. In some embodiments of this disclosure, a LiDAR L1 can include an emitter TX, a receiver RX, and a signal processor apparatus 80 as described in any of the above-mentioned embodiments.

The emitter TX includes multiple lasers (e.g., lasers T1 to Tq shown in FIG. 8, where q is an integer greater than 1). The emitter TX can emit a detection signal.

The receiver RX includes multiple detectors (e.g., lasers R1 to Rp shown in FIG. 8, where p is an integer greater than 1). The receiver RX can receive an echo signal corresponding to the detection signal.

The signal processor apparatus 80 is coupled to the receiver, and can determine a total crosstalk amount caused by other detectors to a target detector. And the signal processor apparatus 80 can determine an actual detection signal of the target detector based on an output signal of the target detector and the total crosstalk amount.

Exemplary implementation of the signal processor apparatus 80 can be referred to an exemplary description of the above-described embodiments, and will not be further described herein.

In some embodiments, any one of the lasers T1 to Tq can emit a detection signal (a detection beam or a laser signal) to outside world. Then, a detector corresponding to the laser can receive an echo signal (a reflection signal) reflected from an obstacle 8A. When the signal processor apparatus 80 determines that the output signal of the detector is a high-reflectivity echo signal based on signal characteristics of the output signal of the detector, the detector is selected as the target detector. Afterwards, the total crosstalk amount caused by other detectors to the target detector is determined. Moreover, the actual detection signal of the target detector is determined based on the output signal of the target detector and the total crosstalk amount. When the signal processor apparatus 80 determines that the output signal of the detector is not the high-reflectivity echo signal based on the signal characteristics of the output signal of the detector, there is no need to determine the total crosstalk amount caused by other detectors to the detector.

In some embodiments of this disclosure, the signal processor apparatus 80 can also be coupled to the emitter TX. After the actual detection signal of the target detector is determined or the output signal is determined, the signal processor apparatus 80 can determine time of flight of the detection signal based on time of emitting the detection signal and time of receiving the echo signal. Further, distance information of the obstacle 8A can be determined. Furthermore, the signal processor apparatus 80 can also determine parameters such as reflectivity of the obstacle 8A for detecting, identifying, or tracking the obstacle 8A.

In some embodiments, a corresponding relationship between the laser and the detector can be flexibly set based on actual needs. For example, the laser and detector can be set one-to-one. That is, q can be equal to p. For another example, one laser can correspond to multiple detectors. That is, q can be less than p. For still another example, one detector can correspond to multiple lasers. That is, p can be less than q. The embodiments of this disclosure do not limit this, as long as the LiDAR can complete a detection process of an obstacle.

In some embodiments of this disclosure, the receiver can include a two-dimensional detector array. The detector array can include multiple detectors arranged in a predetermined array. One or more detectors can act as a pixel point. The pixel point can output detection data. The detection data can form a data point in point cloud after being processed.

It can be understood that the receiver can also be other forms of detectors. For example, the receiver can be a linear detector array. The embodiments of this disclosure do not limit a specific form of the receiver, as long as the receiver can receive an echo signal related to the obstacle.

Although the embodiments of this disclosure are disclosed as above, this disclosure is not limited thereto. Any person skilled in the art can make various changes and modifications without departing from spirit and scope of this disclosure. Accordingly, a protection scope of this disclosure should be subject to a scope limited by claims.

1. A signal processing method for a LiDAR, wherein the LiDAR comprises a plurality of detectors, and the signal processing method comprises:
selecting a target detector, and receiving an output signal of the target detector,
determining a total crosstalk amount caused by other detectors to the target detector, and determining an actual detection signal of the target detector based on the output signal of the target detector and the total crosstalk amount.

2. The signal processing method of claim 1, wherein the selecting the target detector, and receiving the output signal of the target detector comprises:
determining whether an output signal of a detector is a high-reflectivity echo signal, and in response to determining that the output signal is the high-reflectivity echo signal, determining the detector as the target detector.

3. The signal processing method of claim 2, wherein the determining whether the output signal of the detector is the high-reflectivity echo signal comprises:
determining whether the output signal of the detector is the high-reflectivity echo signal based on signal characteristics of the output signal of the detector.

4. The signal processing method of claim 3, wherein the signal characteristics of the output signal comprise at least one of:
a noise value,
an intensity value,
a pulse width of echo waveform, or
a slope of the echo waveform.

5. The signal processing method of claim 1, wherein the determining the total crosstalk amount caused by other detectors to the target detector comprises:
determining all detectors that cause crosstalk to the target detector as crosstalk detectors; and
performing convolution on crosstalk amounts caused by the crosstalk detectors to the target detector to determine the total crosstalk amount.

6. The signal processing method of claim 5, wherein the performing convolution on the crosstalk amounts caused by the crosstalk detectors to the target detector to determine the total crosstalk amount comprises:
determining output signals of respective crosstalk detectors, and determining the crosstalk amounts corresponding to the respective crosstalk detectors based on crosstalk coefficients corresponding to the respective crosstalk detectors, and
combining the crosstalk amounts corresponding to the respective crosstalk detectors to determine the total crosstalk amount.

7. The signal processing method of claim 6, wherein the determining the output signals of the respective crosstalk detectors, and the determining the crosstalk amounts corresponding to the respective crosstalk detectors based on the crosstalk coefficients corresponding to the respective crosstalk detectors comprises:
determining products of the crosstalk coefficients corresponding to the respective crosstalk detectors and signal intensities of the output signals as the crosstalk amounts corresponding to the respective crosstalk detectors.

8. The signal processing method of claim 6, wherein the crosstalk coefficients are related to distances between the crosstalk detectors and the target detector.

9. The signal processing method of claim 8, further comprising:
determining obstacle distances based on the output signal of the target detector and the output signals of the respective crosstalk detectors, and in response to a difference between an obstacle distance corresponding to a respective crosstalk detector and the obstacle distance corresponding to the target detector exceeding a predetermined distance threshold, setting a crosstalk coefficient of the respective crosstalk detector to zero.

10. The signal processing method of claim 1, wherein the determining the actual detection signal of the target detector based on the output signal of the target detector and the total crosstalk amount comprises:
determining the actual detection signal by subtracting the total crosstalk amount from the output signal of the target detector.

11. The signal processing method of claim 1, further comprising:
determining whether a signal intensity of the actual detection signal exceeds a predetermined detection threshold to determine whether the actual detection signal is a valid signal.

12. A signal processor apparatus for a LiDAR, wherein the LiDAR comprises a plurality of detectors, and the signal processor apparatus comprises:
a sampler, configured to sample an output signal of a target detector, and
a processor, configured to determine a total crosstalk amount caused by other detectors to the target detector, and configured to determine an actual detection signal of the target detector based on the output signal of the target detector and the total crosstalk amount.

13. A LiDAR, comprising:
an emitter, comprising a plurality of lasers, configured to emit a detection signal,
a receiver, comprising a plurality of detectors, configured to receive an echo signal corresponding to the detection signal, and
a signal processor apparatus, coupled to the receiver, configured to determine a total crosstalk amount caused by other detectors to a target detector, and configured to determine an actual detection signal of the target detector based on the output signal of the target detector and the total crosstalk amount.

14. The LiDAR based on claim 13, wherein the receiver comprises a two-dimensional detector array.
